(19) United States
(12) Patent Application Publication
(10) Pub. No.: US 2007/0136473 A1
(43) Pub. Date: Jun. 14, 2007

(54) Method for selecting a communications network mode having an optimum efficiency

(76) Inventors: Mark A. Birchler, Roselle, IL (US); Michael H. Baker, Elmhurst, IL (US); Michael S. Johnson, Orlando, FL (US); Robert M. Johnson, Lake Zurich, IL (US); Surender Kumar, Naperville, IL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/301,717

(22) Filed: Dec. 13, 2005

(51) Int. Cl. G06F 15/173

(52) U.S. Cl. 709/226

(57) ABSTRACT

A method for utilizing a personal agent in a communications device for selecting the method of delivery of at least one communication having multiple networking type modes (200) includes discovering all available delivery options (203). One or more operational parameters are detected (205) including information based on the agent's knowledge of the user's schedule. The impact on battery consumption of the communication is also estimated (209) and a key metric is determined (211) based on the type of delivery options that are available. Finally, an optimal delivery option is determined (213) where it can be either automatically selected or presented to the user of the device.

### FIELD OF THE INVENTION

The present invention relates generally to communications system mode selection and more particularly to a method for automatically selecting from one of numerous communications options for providing the most optimum efficiency.

### BACKGROUND

Communications networks can operate today using multiple modes such as mesh, peer-to-peer and/or direct communications, thus posing complex challenges in the selection of the means by which to accomplish a given service request. As a node or device in the network prepares to send and or receive communications, it is often difficult to determine what is the most efficient and cost effective means by which to establish communications. In some instances, a mesh communication (i.e., infrastructure and devices cooperating to route traffic to the desired destination) may be a better choice while in others communicating with other devices (i.e., peer-to-peer) may be more efficient. In still other cases, communicating directly through the infrastructure provided by a cellular (or Wi-Fi, etc.) network is the best option.

Those skilled in the art will recognize that mesh, peer-to-peer and direct communication operate differently. A wireless mesh network topology works as a point-to-point-to-point system communicating messages in an ad hoc, multi-hop fashion. The mesh node can send and receive messages as well as functioning as a router to relay messages for its neighbors. Through the relaying process, a packet of wireless data will find its way to its destination, passing through intermediate nodes (devices and infrastructure) with reliable communication links. One advantage of this type of router-based network is that it offers multiple redundant communications paths. If one link fails for any reason (including the introduction of strong radio frequency (RF) interference), the network can automatically route messages through alternate paths. The mesh network allows paths between nodes to be shortened which can dramatically increases the link quality. This allows mesh links to be more reliable without increasing transmitter power in individual nodes. Similarly, peer-to-peer networking enables devices to communicate directly with each other, without the use of infrastructure (e.g., an access point or a cellular base station). Finally, the direct communications network is one where the device communicates directly with pre-positioned infrastructure (e.g., an access point or a cellular base station).

Similar systems have been disclosed in the prior art including U.S. Patent Publication 2005/0084082 which discloses a system using identity and context sensitive decision asking for handling channel selection, routing and rescheduling operations. This invention focuses on maximizing communication value between individuals as compared to operating to select specific wireless communication methods. Similarly U.S. Patent Publication 2005/0141706 discloses a system for secure ad hoc mobile communications where a mobile agent operates to use traditional applications into a network concentric application. The problem associated with this type of system is that the focus is on security issues as opposed to wireless communication method selection.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a flow chart diagram illustrating an overview of a method for selecting optimum efficiency in accordance with an embodiment of the invention.

FIG. 2 is a flow chart diagram illustrating steps for determining an optimum mode of communication in a communications network in accordance with the overview diagram shown in FIG. 1.

FIG. 3 is a flow chart diagram illustrating a battery life model used in an embodiment of the invention.

FIG. 4 illustrates tables used in a mathematical model showing a set of operational states of the device in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a method for selecting optimum efficiency in a communications network having multiple communications modes. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of a method for selecting optimum efficiency in a communications network having multiple communications modes as described herein. The non-processor circuits may include, but are not limited to, a radio receiver, a radio transmitter, signal drivers, clock circuits, power source circuits, and user input devices. As such, these functions may be interpreted as steps of a method to perform a method for selecting optimum efficiency in a communications network having multiple communications modes. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

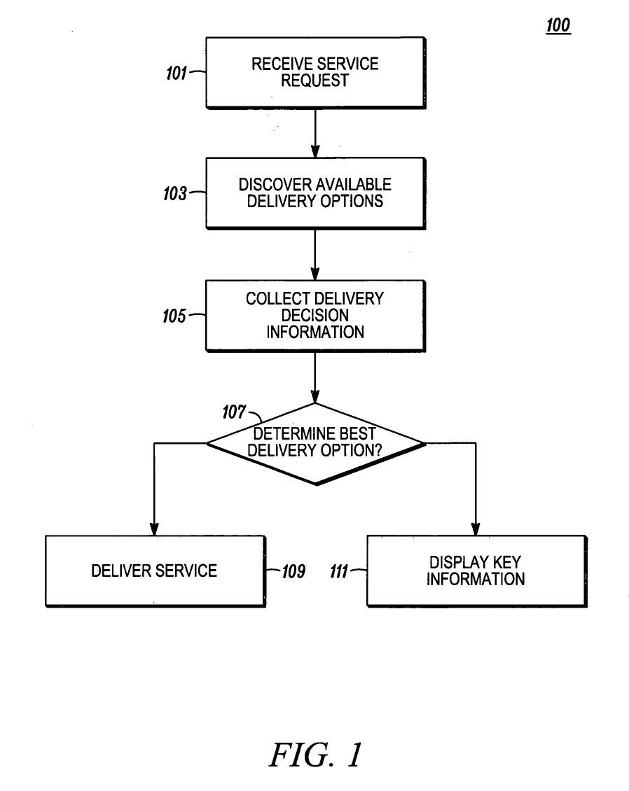

Turning now to FIG. 1, an electronic device such as a cellular telephone, two-way radio transceiver or the like utilizes personal agent software and/or a method 100 performed by a communications network to select an optimum efficiency for a selected communication. It will be appreciated by those of ordinary skill in the art that the device can contain multiple transceivers and supporting systems to enable communication using multiple wireless solutions (e.g., cellular and wireless local area network (WLAN)). In one embodiment of the invention, the method includes the steps of first receiving a service request 101. Once received the device would discover all available delivery options 103 and collect delivery decision information 105. This information is then used to determine the best delivery option 107 of the voice and/or data communication where it can be delivered 109 or key information can be displayed 111. Typically, the user device would also collect delivery decision information immediately after power-up. After power-up the device would do neighbor scanning on one or more of the “seamless” alternatives and select systems for initial association to facilitate immediate communication. An alternate embodiment would collect and store operational and environmental information associated with each delivery option during the scanning and association periods and have information readily available at the time a new service request was received. Typical information collected could include temperature, voltages and currents of components or modules, received signal strength, received signal to noise level and link quality metrics.

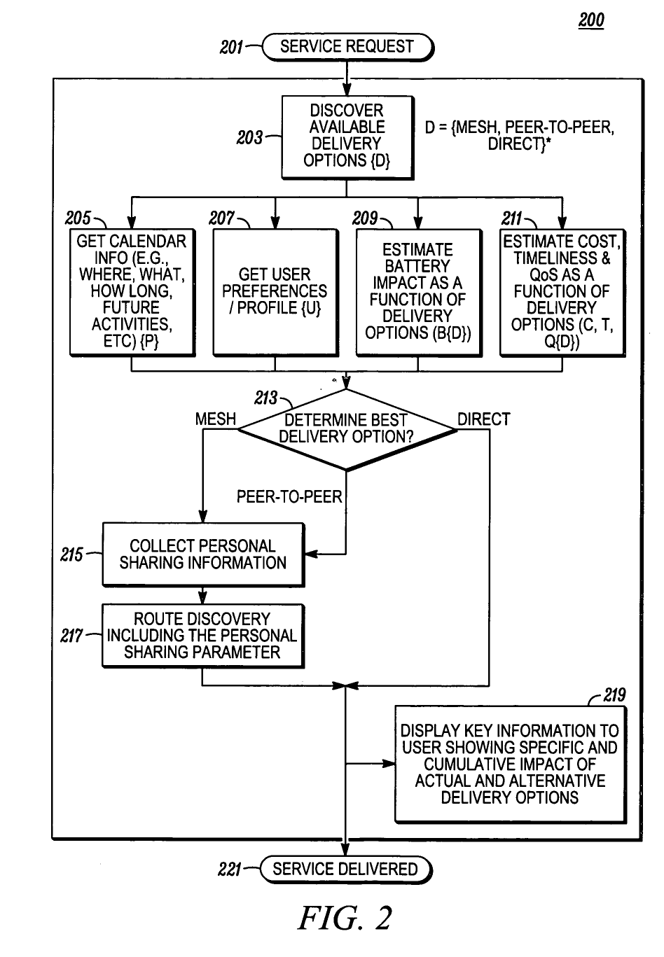

FIG. 2 is a more detailed flow chart diagram of that shown in FIG. 1, which illustrates the methods used to select the optimum efficiency in a communications network with multiple operational modes. The method as described in the flow chart 200 includes receiving a service request 201 where all available delivery options are subsequently discovered 203. The delivery options can include, for example, communication of voice, data or other communications using a mesh, peer-to-peer or direct networking arrangement, or any other communication mechanism as is known in the art. In order to determine the best and most optimal delivery options series of metrics are generated in order to make this determination. These can, for example, include:
1) Determining all relevant calendar information 205 including but not limited to the users physical or geographic location, what activity is being performed, the duration of the activity and any future activities that will require communications using the electronic device. Based on the knowledge that the device has of the users schedule (e.g., geographic location, current activity, the duration of the activity and what is planned for the near future) information that could affect the optimum communication mode is generated.
2) Determining the user preferences/profile 207 where the user may have indicated the preference in the type of network communication that should be used;
3) Estimating the battery impact as a function of delivery options 209 where internal models are used to estimate the battery consumption of the service request as a function of the delivery options. Since it is likely that future battery requirements will be based on a users schedule, interpretation of calendar information can be very helpful in estimating future battery requirements; and
4) Estimating one or more key metrics such as cost, timeliness and quality of service (QoS) as a function of delivery options 211. This step is typically implemented if the type of service request such as Voice-over-IP (VoIP), best effort, time critical/non-critical metrics are used allowing for these metrics to contribute to the decision in selecting a network communication type.

The best delivery option is then determined 213 using an algorithm or other means to evaluate each of the conditions 205 to 211. The type of communication namely mesh, peer-to-peer or direct is determined 213. Regardless of the selected communication mode, key information is displayed 219 to the user showing specific and cumulative impact on the actual and alternate delivery options. If either the mesh or peer-to-peer option is selected, personal sharing information is collected 215.

In one embodiment the personal agent process generates a set of metrics using an algorithm, based on delivery options such as those mentioned above and selects the communication network mode that provides optimal efficiency. Thus, the invention allows the user to be presented with options for sending and receiving communications where multiple communications types are available. These communication options may include but are not limited to mesh, peer-to-peer and direct communications which the method of the invention allows an optimal and most efficient types of communication to be selected.

With regard to the battery life model, battery estimation 209 uses information from the discovery 101 and collection 103 phases that are input to a battery model. The battery life model is typically located in an application processor and estimates or measures battery drain for the present mode. It may also predict battery life for alternate modes. Thus, the invention, uses a battery life estimator to provide battery usage decision information B{Dₙ} where Dₙ represents battery drain. The battery life model can make use of either measurements of battery drain parameters (power and time spent) or mathematical estimates of battery drain parameters.

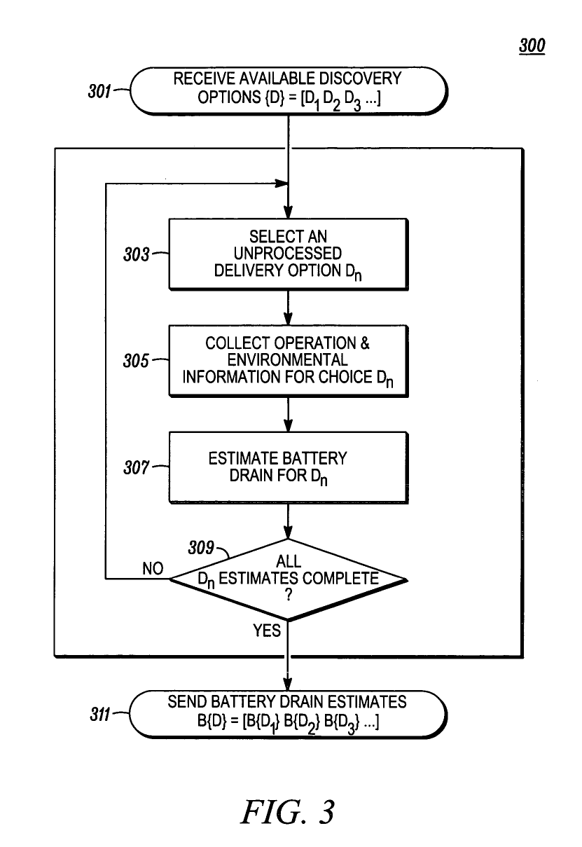

FIG. 3 provides a high level overview of an implementation of a method 300 for the battery life estimator. The battery life estimator receives information 301 on the set of delivery options for which estimates must be made. The set of delivery options, D, can be represented as a vector D=[D₁ D₂ D₃ . . .]. Battery life estimates are made for each of the delivery option elements Dₙ within the vector D. An unprocessed option Dₙ is selected 303 from the input set D and information is collected 305 that is needed for battery drain estimation. Battery drain B{Dₙ} is then estimated using a mathematical model 307. A decision block 309 checks to see if battery drain estimates have been made for all delivery options. If not, then the flow returns to 303 where a next delivery option is selected and this next option is then processed in a like manner through the flowchart. Once all delivery options have been processed the final set of battery drains B{D}=[B{D₁} B{D₂} B{D₃} . . . ] is communicated 311.

Mathematical models for estimation of power drain are familiar to those skilled in the art of communications equipment design. During product development, battery life spreadsheets are created to estimate talk and standby time for mobile devices. In these spreadsheets, battery life is estimated by multiplying the amount of time a device operates in each of several different power consumption states by the individual component current drains obtained for each circuit within the mobile device.

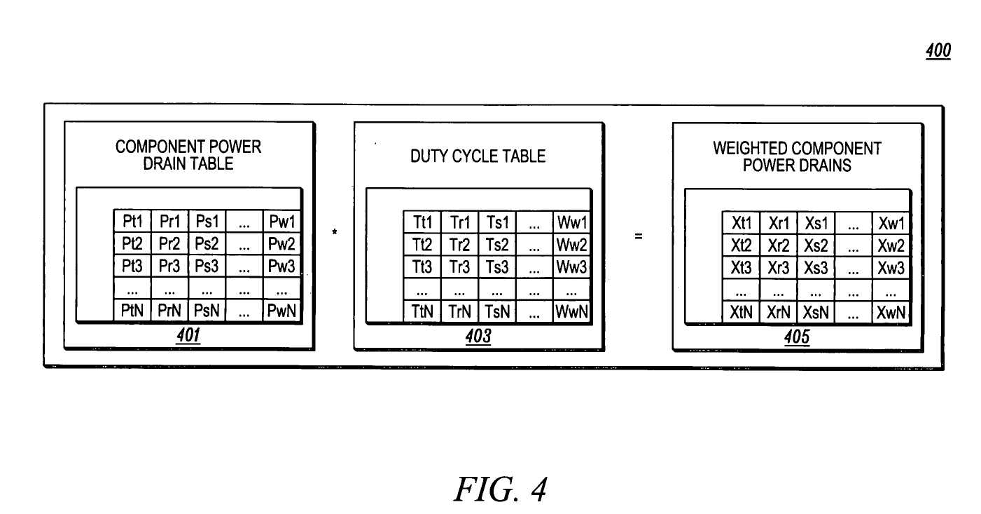

A depiction of a mathematical model for estimating battery drain is shown in FIG. 4. The power consumption of a mobile device may be estimated by tracking the amount of time a mobile device spends in each power state 401, which typically consists of transmit, receive, sense/scan, doze, and warm-up states (or modes). The power consumption B{Dₙ} for a specific delivery option Dₙ of a given mobile device can be estimated by performing a weighted average of the power consumption in each state by using the amount of time spent in each state as its weight. This time weighting is generally known as a duty cycle. The weighted average operation can be represented by the mathematical formula in Equation (1).
B{Dₙ}=Tsₙ*Psₙ+Ttxₙ*Ptxₙ+Trxₙ*Prxₙ+Twₙ*Pwₙ+Tslₙ*Pslₙ (1)
where Tsₙ, Ttxₙ, Trxₙ, Twₙ, and Tslₙ denote the percentage of time spent in the sensing, transmitting, receiving, waking up, and dozing states over the entire call duration, respectively for delivery option Dₙ. Similarly, Psₙ, Ptxₙ, Prxₙ, Pwₙ, and Pslₙ represent the power consumption at sensing, transmitting, receiving, waking up, and dozing states, respectively for delivery option Dₙ.

As shown in FIG. 3, information gathered 305 during the collection process is used to update tables within the mathematical model shown in FIG. 4 for a set of operational states that include but are not limited to sensing, transmitting, receiving, waking up, and dozing. The component power estimates 401 are a function of the delivery option {Dₙ} as well as collection parameters including but not limited to the frequency of operation, battery voltage, type of neighbor scanning algorithm, and component temperatures. A duty cycle estimation table 403 is also updated for each operational state. The duty cycle estimates are a function of the delivery option {Dₙ} as well as collection parameters including but not limited to received signal strength, signal to noise ratio, type of neighbor scanning algorithm, number of neighbors to scan per delivery type, link quality, access point loading, and type of traffic.

Once the power and duty cycle tables have been updated, the battery drain of each individual component is then calculated. The individual contributions of each component (n) at each state to the total power drain is calculated by multiplying the component power estimates by the duty cycle for that state. For example, for state (t), delivery option (n) and component (j) component power drain is given by Equation (2).
Xtₙ(j)=Ptₙ(j)*Ttₙ(j) (2)

The total battery drain for a given delivery option (n) is found by a summation of all the component current drains for each state using Equation (3)
B{Dₙ}=ΣXtₙ(j)+ΣXrₙ(j)+ΣXsₙ(j)+ . . . +ΣXwₙ(j) (3)
where each summation is made over all components (j) within the device.

Those skilled in the art will recognize situations exist where it is preferable to use measured power levels in place of individual component power estimates 401 and/or measured duty cycles in place of individual duty cycle estimates 403.

Those skilled in the art will also recognize that it may be preferable to make measurements on blocks of components at one time and replace portions of columns within power estimates 401 and/or duty cycle estimates 403 with measured values rather than mathematical estimates. Any of the estimates shown in component power estimates 401 or duty cycle estimates 403 may be replaced by their respective measured values. Circuits to measure the voltages and currents necessary for power estimation and circuits to measure duty cycle time durations are well known to those skilled in the art.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method for selecting a communications network mode for a communication having an optimal efficiency where multiple operational networks types are available comprising the steps of:
determining all available delivery options among multiple networking modes;
determining operational parameters for the selected communication;
determining user preferences for the selected communication;
estimating at least one key metric as a function of delivery option; and
determining an optimal delivery option for the selected communication.

2. A method for selecting a communications network mode having an optimal efficiency as in claim 1, where the network mode include at least one from the group of mesh network communications, peer-to-peer network communication or direct communication.

3. A method for selecting a communications network mode having an optimal efficiency as in claim 1, wherein the user preferences include the user's preference type based on a past communications history

4. A method for selecting a communications network mode having an optimal efficiency as in claim 1, wherein the user preferences include the user's preference type based on a stored user profile.

5. A method for selecting a communications network mode having an optimal efficiency as in claim 1, wherein the operational parameters include at least one from the group of: location of the communication, type of communication and duration of the communication.

6. A method for selecting a communications network mode having an optimal efficiency as in claim 1, wherein the step of estimating at least one key metric includes the step of:
estimating the cost of the communication as a function of operational network type.

7. A method for selecting a communications network mode having an optimal efficiency as in claim 1, wherein the step of estimating at least one key metric includes the step of:
estimating the timeliness of the communication as a function of operational network type.

8. A method for selecting a communications network mode having an optimal efficiency as in claim 1, wherein the step of estimating at least one key metric includes the step of:
estimating a quality of service (QoS) as a function of operational network type.

9. A method for selecting a communications network mode having an optimal efficiency as in claim 1, further including the step of:
presenting the user with a choice of optimal delivery option.

10. A method for selecting a communication network mode having an optimal efficiency as in claim 1, further including the step of:
automatically selecting the optimal delivery option.

11. A method for utilizing a personal agent in a communications device for selecting the method of delivery of at least one communication having multiple networking type modes comprising the steps of:
detecting all available delivery options;
detecting at least one operational parameter for at least one communication based on the agents knowledge of the user's schedule;
estimating the impact on battery consumption of at least one communication on the communications device;
estimating at least one key metric based on the type of delivery options that are available; and
determining an optimal delivery option

12. A method for utilizing a personal agent in a communications device as in claim 11, wherein the delivery options include at least one of the group of mesh network communications, peer-to-peer communications and direct communications.

13. A method for utilizing a personal agent in a communications device as in claim 11, wherein the operational parameter includes at least one from the group of user geographical location, user activity, activity duration and future activities.

14. A method for utilizing a personal agent in a communications device as in claim 11, wherein the step of estimating at least one key metric includes the step of:
estimating the timeliness of the communication;
estimating a quality of service (QoS) of the communication; and
estimating the cost of the communication.

15. A method for utilizing a personal agent in a communications device as in claim 11, further including the step of:
presenting the user with a choice of delivery option including the optimal delivery option.

16. A method for utilizing a personal agent to collect information regarding the type of service request for recommending a communication delivery mode, comprising the steps of:
determining all available delivery options;
determining user schedule information based an electronic calendar;
utilizing a user preferences profile to determine user communication mode preferences;
determining the impact of battery function based on available delivery options;
estimating at least one key metric for use in the recommendation; and
recommending a delivery mode.

17. A method for utilizing a personal agent to collect information as in claim 16, wherein the delivery options include at least one from the group of mesh network communications; peer-to-peer network communications or direct communications.

18. A method for utilizing a personal agent to collect information as in claim 16, wherein the user schedule information includes at least one from the group of user location, user activity, activity duration and future activity.

19. A method for utilizing a personal agent to collect information as in claim 16, wherein the at least one key metric includes at least one from the group of cost estimate, call timeliness or quality of service (QoS).

20. A method for utilizing a personal agent to collect information as in claim 16, further comprising the step of:
presenting the user with a choice of delivery mode.
